(19) United States
(12) Patent Application Publication
(10) Pub. No.: US 2025/0315299 A1
(43) Pub. Date: Oct. 9, 2025

(54) AUTOSCALING FOR MICROSERVICES

(71) Applicant: SAP SE, Walldorf (DE)

(72) Inventor: Hui LI, Shanghai (CN)

(21) Appl. No.: 18/630,343

(22) Filed: Apr. 9, 2024

(51) Int. Cl. G06F 9/50

(52) U.S. Cl. CPC G06F 9/5027

(57) ABSTRACT

Systems and methods include reception, at a first microservice of a microservice-based application, of an indicator of a workload of an entry microservice of the microservice-based application, determination, based on the indicator of the workload, of an estimated future workload of the first microservice, and re-allocation of computing resources to the first microservice based on the estimated future workload.

### BACKGROUND

A microservice-based application consists of distinct functions implemented using independently-deployed microservices. A request directed to a microservice-based application is processed using several microservices, each of which executes in its own computing process in a separate computing system (e.g., server/virtual machine/container) and is independently accessible. Advantageously, each microservice of a microservice-based application may be modified and redeployed without redeploying the entire application.

Microservices are often implemented in the cloud in order to leverage the redundancy, economies of scale and other benefits provided by cloud platforms. One such benefit is resource elasticity, which allows the computing resources (e.g., CPU power, memory size, and network bandwidth) consumed by a microservice to be efficiently scaled up and scaled down according to the needs of the microservice. For example, as CPU usage, memory usage, and/or RPS (incoming requests per second) of a microservice increase beyond a threshold, additional resources may be allocated to the microservice. Similarly, resources may be deallocated from the microservice if CPU usage, memory usage, and/or RPS decrease below a given threshold. Resource costs for operating the microservice may be thereby reduced in comparison to systems in which resources are fixedly allocated to serve a maximum anticipated workload.

The above approach requires time to allocate/deallocate microservice resources, during which the microservice may operate at low efficiency. The time delays accumulate for requests which cross several microservices. Assuming a request which requires successive execution of microservices service₁, service₂, service₃, service₄, high traffic at service₁ may trigger upscaling of resources for service₁. After some time, the high traffic hits service₂ and additional time is required to scale resources for service₂. Similar time delays occur at service₃ and at service₄ due to the scaling of corresponding resources. The whole system is in an unstable state during these time delays, which may result in slow processing and/or errors.

Systems are desired for efficient autoscaling of microservices while addressing the accumulation of time delays as described above.

### BRIEF DESCRIPTION OF THE DRAWINGS

FIG. 1 illustrates a system for resource scaling in a microservice-based system according to some embodiments.

FIG. 2 illustrates a scalable microservice according to some embodiments.

FIG. 3 is a flow diagram of a process for resource scaling in a microservice-based system according to some embodiments.

FIG. 4 illustrates a microservice-based system according to some embodiments.

FIG. 5 illustrates a system for resource scaling within multiple microservices in a microservice-based system according to some embodiments.

FIG. 6 illustrates a system for resource scaling within multiple microservices in a microservice-based system according to some embodiments.

FIG. 7 illustrates a system for resource scaling within multiple microservices in a microservice-based system according to some embodiments.

FIG. 8 illustrates a cloud-based architecture according to some embodiments.

### DETAILED DESCRIPTION

The following description is provided to enable any person in the art to make and use the described embodiments. Various modifications, however, will remain readily-apparent to those in the art.

Some embodiments facilitate proactive resource scaling in a microservices-based system. Briefly, functions are determined to map incoming workloads to expected future workloads at each microservice in a microservices-based system. The incoming workloads are monitored and the functions are used to estimate the workload expected at each microservice based on the incoming workloads. Resources associated with each microservice may then be scaled according to the expected workload. Some embodiments may therefore initiate resource scaling at a microservice before the microservice experiences a substantive change in workload, and may allow the resources of the microservice to be suitably configured for handling the changed workload by the time the workload changes.

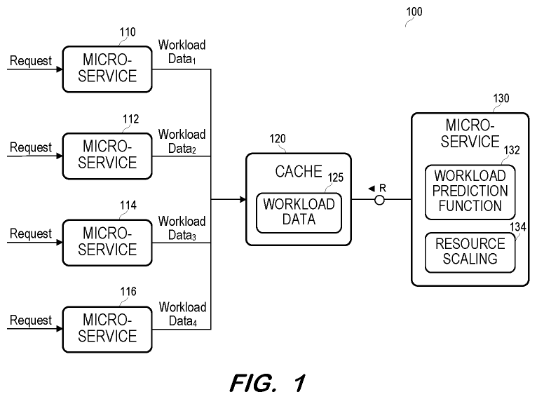

FIG. 1 illustrates a system according to some embodiments. The illustrated components of FIG. 1 may be implemented using any suitable combinations of computing hardware and/or software that are or become known. Computing landscape 100 may comprise any number of hardware and software components which provide functionality to one or more users (not shown). Such combinations may include on-premise servers, cloud-based servers, and/or elastically-allocated virtual machines. In some embodiments, two or more components are implemented by a single computing device.

Computing landscape 100 includes microservices 110-116 and 130. Each of microservices 110-116 and 130 may be provided by a separate execution environment (e.g., a separate process in a separate computing system). Microservices 110-116, 130 and any unshown microservices of computing landscape 100 may be microservices of one or more microservice-based applications. Microservices 110-116 and 130 may communicate with one another and with other unshown microservices using lightweight network communication mechanisms such as a resource Application Programming Interface (API) via Hyper Text Transfer Protocol (HTTP) request-response messages, but embodiments are not limited thereto.

Microservices 110-116 receive incoming requests from external clients. For example, a gateway receives a request (e.g., an API call) associated with a microservice-based application from a client device. The gateway determines a microservice of the microservice-based application to which the request should be forwarded. The request is forwarded to one of microservices 110-116, depending on the type of the request.

Each of microservices 110-116 is configured to receive at least one type of request from the gateway. Accordingly, microservices 110-116 will be referred to herein as entry microservices. Microservices which only receive requests from other microservices will be referred to as interior microservices. An entry microservice executes processing on a received request, which may include calling another microservice (including another entry microservice of computing landscape 100), which may in turn call another microservice of computing landscape 100, and so on until a response to the request is returned.

During operation, microservices 110-116 receive requests as shown in FIG. 1. Each of microservices 110-116 also provides data indicative of their respective workloads (i.e., workload data) to cache 120 during operation. The workload data may consist of a number of requests per second (RPS) received by a microservice but embodiments are not limited thereto. For example, workload data may consist of average memory consumption, average CPU usage or other suitable workload indicators. The workload data of each of microservices 110-116 may be generated by a monitoring component of each microservice in some embodiments.

Cache 120 may comprise any data storage system which is centrally-available to microservices of landscape 100, including but not limited to a key-value in-memory database (e.g., a Redis cluster). Cache 120 may store received workload data 125 in any suitable format. Cache 120 is also capable of responding to queries of workload data 125.

Microservice 130 is an interior microservice of landscape 100. Landscape 100 likely includes many interior microservices and microservice 130 is considered to be merely an example thereof. Microservice 130 receives calls from one or more other microservices of landscape 100 during the processing of a request received by one of entry microservices 110-116.

Microservice 130 includes workload prediction function 132 which has been previously determined and provided thereto as will be described below. Workload prediction function 132 maps workloads of entry microservices 110-116 to workloads of microservice 130. Workload prediction function 132 may consist of program code, a formula and pre-calculated constants, a trained machine learning model, etc.

During operation of landscape 100, microservice 130 may periodically request most-recent workload data of workload data 125 from cache 120. The most-recent workload data includes workload data of each of entry microservices 110-116. Microservice 130 receives the requested workload data from cache 120 and uses workload prediction function 132 and the requested workload data to determine its own expected workload.

Resource scaling component 134 may determine whether any computing resources allocated to microservice 130 should be scaled (i.e., increased or decreased) in view of the expected workload. In one example, resource scaling component 134 determines a resource profile based on the expected workload which represents a predetermined level of computing resources (e.g., CPU number and type, memory size and type, network bandwidth) suitable to handling the expected workload and compares the resource profile to the current resources allocated to microservice 130. Resource scaling component 134 may then initiate scaling of the current computing resources to conform the current resources to the determined resource profile.

Scaling of resources allocated to microservice 130 may be performed in any manner that is or becomes known. Cloud environments generally provide systems to elastically allocate computing resources to virtual machines based on demand. Microservices are often deployed in containers managed by a container orchestration platform which provides efficient autoscaling.

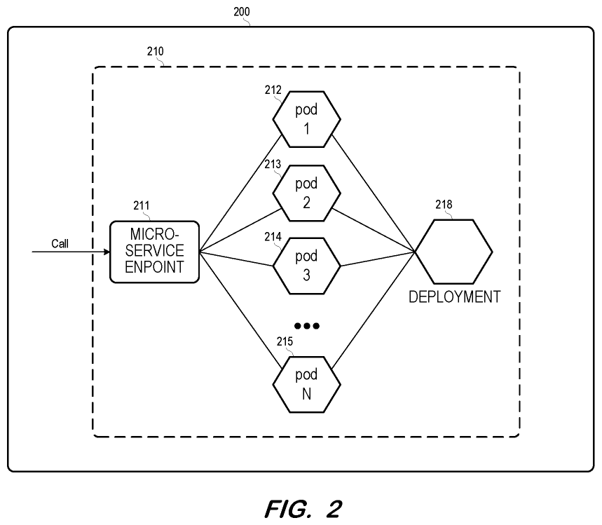

FIG. 2 illustrates interior microservice 210 deployed in container orchestration platform 200 such as but not limited to Kubernetes. Microservice 210 contains N pods 212-215, each of which may independently provide the functionality of microservice 210. Each of pods 212-215 is a collection of one or more containers and runs on a virtual or a physical machine known as a node. A node may execute multiple pods. According to some embodiments, microservice endpoint 211 receives a call from another microservice and routes the call to one of pods 212-215 for processing thereof.

Deployment component 218 may adjust the number of pods, the number of nodes and/or the computing resources of each node based on the expected workload of microservice 200. For example, if the expected workload is greater than a first threshold, deployment 218 will create one or more additional pods. If the expected workload is less than a second threshold, deployment 218 will terminate one or more of pods 212-215.

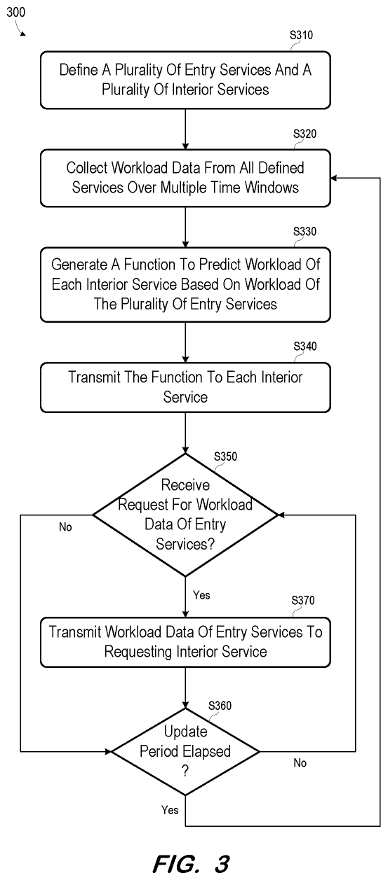

FIG. 3 is a flow diagram of process 300 for resource scaling in a microservice-based system according to some embodiments. Process 300 and the other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

At S310, a plurality of entry services and a plurality of interior services are defined. The terms service and microservice are used interchangeably herein. The plurality of entry services and the plurality of interior services may be services of one or more applications. In a case that the plurality of entry services and the plurality of interior services are services of more than one application, one or more of the entry services and the plurality of interior services may be used by more than one application.

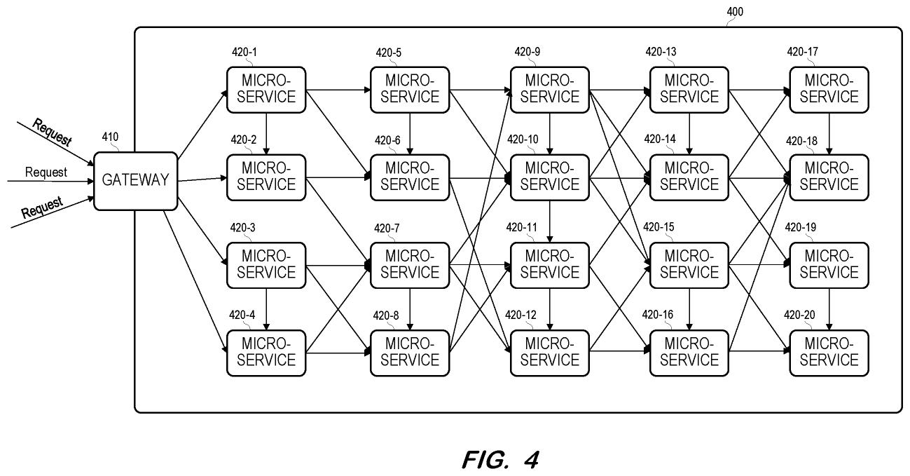

FIG. 4 illustrates landscape 400 including a plurality of entry services 420-1 to 420-4 and a plurality of interior services 420-5 to 420-20 according to some embodiments. Gateway 410 receives incoming requests to the one or more applications of landscape 400 and routes the incoming requests to the appropriate one of entry services 420-1 to 420-4. Gateway 410 may also provide authentication, authorization, and load balancing in some embodiments. Entry services 420-1 to 420-4 call other services of landscape 400, which in turn call other services, in order to process the incoming requests. Entry services 420-2 and 420-4 receive requests from gateway 410 and calls from services 420-1 and 420-3, respectively, but are nonetheless defined as entry services.

Landscape 400 operates to serve incoming requests at S320. During such operation, workload data is collected from each of services 420-1 to 420-20 for each of multiple time windows. One or more monitoring components within landscape 400 (e.g., within each execution environment of each microservice) may generate the workload data, which may be collected in a central data storage system such as cache 120. The collected data consists of, for each of multiple time windows, the workload data of each of services 420-1 to 420-20.

At S330, functions are generated to predict the workload of each interior service based on the workloads of each of the entry services. Some embodiments use a linear regression model to generate the functions at S330. Using RPS as the workload data, rpsᵢ is defined as the RPS of service₄₂₀₋ᵢ. Accordingly, rpsᵢ (i∈[5, 20]) may be determined from [rps₁, rps₂, rps₃, rps₄] by the formula rpsᵢ=a_{i,0}+a_{i,1}×rps₁+a_{i,2}×rps₂+a_{i,3}×rps₃+a_{i,4}×rps₄ (i∈[5, 20]).

Using matrix notation, the above formula may be written as:

$$[ \begin{matrix}{rps}_{5} \\ {rps}_{6} \\ {rps}_{7} \\ … \\ {rps}_{20}\end{matrix} ] = [ \begin{matrix}{a}_{5 , 0} & {a}_{5 , 1} & {a}_{5 , 2} & {a}_{5 , 3} & {a}_{5 , 4} \\ {a}_{6 , 0} & {a}_{6 , 1} & {a}_{6 , 2} & {a}_{6 , 3} & {a}_{6 , 4} \\ {a}_{7 , 0} & {a}_{7 , 1} & {a}_{7 , 2} & {a}_{7 , 3} & {a}_{7 , 4} \\ … & … & … & … & … \\ {a}_{20 , 0} & {a}_{20 , 1} & {a}_{20 , 2} & {a}_{20 , 3} & {a}_{20 , 4}\end{matrix} ] [ \begin{matrix}1 \\ {rps}_{1} \\ {rps}_{2} \\ {rps}_{3} \\ {rps}_{4}\end{matrix} ] \qquad ( 2 )$$

where a_{i,0}, a_{i,1}, a_{i,2}, a_{i,3}, a_{i,4} are constants.

The rpsᵢ of every service₄₂₀₋ᵢ collected at S320 for each of N time windows [Δt₁, Δₜ₂, Δₜ₃, . . . , Δt_{N}] is denoted [rpsᵢ⁽¹⁾, rpsᵢ⁽²⁾, rpsᵢ⁽³⁾, . . . , rpsᵢ^{(N)}], allowing the definition of matrix X and vectors yᵢ as follows:

$$X = [ \begin{matrix}1 & {rps}_{1}^{( 1 )} & {rps}_{2}^{( 1 )} & {rps}_{3}^{( 1 )} & {rps}_{4}^{( 1 )} \\ 1 & {rps}_{1}^{( 2 )} & {rps}_{2}^{( 2 )} & {rps}_{3}^{( 2 )} & {rps}_{4}^{( 2 )} \\ 1 & {rps}_{1}^{( 3 )} & {rps}_{2}^{( 3 )} & {rps}_{3}^{( 3 )} & {rps}_{4}^{( 3 )} \\ … & … & … & … & … \\ 1 & {rps}_{1}^{( N )} & {rps}_{2}^{( N )} & {rps}_{3}^{( N )} & {rps}_{4}^{( N )}\end{matrix} ]$$

$${y}_{i} = {[ \begin{matrix}{rps}_{i}^{( 1 )} , & {rps}_{i}^{( 2 )} , & ... , & {rps}_{i}^{( N )}\end{matrix} ]}^{T} ( i ∈ [ 5 , 20 ] )$$

Consequently, the constants a_{i,0}, a_{i,1}, a_{i,2}, a_{i,3}, a_{i,4} for each service₄₂₀₋ᵢ can be calculated by the least squares method as aᵢ=[a_{i,0}, a_{i,1}, a_{i,2}, a_{i,3}, a_{i,4}]^{T}=(X^{T}X)⁻¹X^{T}yᵢ (i∈[5, 20]).

Embodiments are not limited to the above determination of the workload prediction function. For example, a workload prediction function may be determined for each interior service using a supervised learning regression model. For a given interior service, each training data sample consists of the workload data of each entry service at a given time window and a ground truth value equal to the workload data of the interior service at the given time window. Accordingly, a separate model may be trained for each interior service.

The determined functions are transmitted to each respective interior service at S340. Referring to the above examples, the constants a_{i,0}, a_{i,1}, a_{i,2}, a_{i,3}, a_{i,4} for a service₄₂₀₋ᵢ may be transmitted to service₄₂₀₋ᵢ, or each trained model may be transmitted to its respective service.

According to some embodiments, landscape 400 continues to serve incoming requests during S310-S340. Moreover, workload data of the entry services continues to be collected during S310-S340. Flow cycles between S350 and S360 to wait for a request for workload data of the entry services or for a function update period to elapse. Assuming that a request for workload data of the entry services is received from an interior service at S350, the requested workload data is transmitted to the requesting interior service at S370. The transmitted workload data may be the most-recently stored workload data of the entry services. In some embodiments, the entry services are queried for their current workload data in response to the request received at S350 and the current workload data is transmitted at S370.

As described above, the requesting interior service may use the received workload data and the function received at S340 to determine an expected workload. Computing resources may then be allocated to or de-allocated from the interior service based on the expected workload.

Flow continues to cycle between S350 and S360 to wait for workload data requests or for a function update period to elapse. The function update period may be a predetermined period after which the workload prediction functions are to be re-determined, and/or may be based on operational data of landscape 400 such as statistics indicating a change in workload distribution, removal or addition of a microservice, or the like. Once it is determined that the update period has elapsed, flow returns to S320 to collect workload data from which new functions will be generated and transmitted to the interior services as described above.

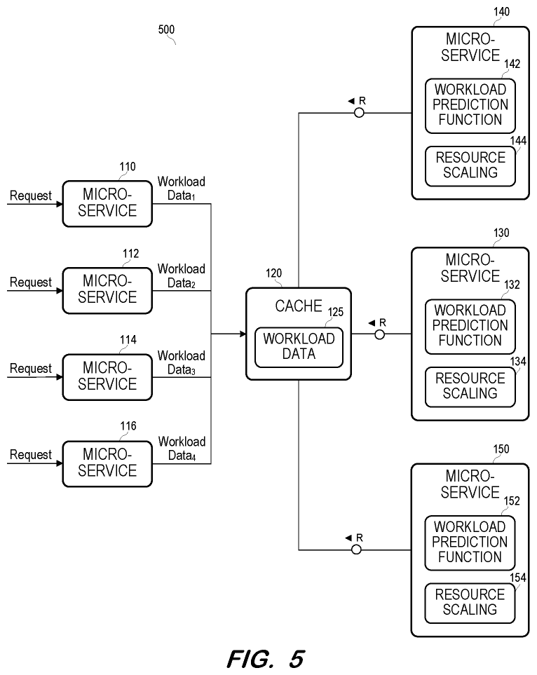

FIG. 5 illustrates resource scaling within multiple microservices in microservice-based system 500 according to some embodiments. Each of microservices 140 and 150 comprise interior microservices as described herein.

Each of workload prediction functions 132, 142 and 152 may be transmitted to its respective microservice at S340 as described above. Workload prediction function 132 may comprise a function to determine an expected workload of microservice 130 based on workloads of entry services 110-116, while workload prediction functions 142 and 152 may comprise function to determine an expected workload of microservices 140 and 150, respectively, based on workloads of entry services 110-116.

Microservices 130, 140 and 150 may operate to scale their respective resources independently of one another. For example, microservices 130, 140 and 150 may request workload data from cache 120 at different times and/or at different time intervals. Similarly, microservices 130, 140 and 150 may perform resource scaling at different times and/or at different time intervals.

Resource scaling components 134, 144 and 154 may be governed by different scaling rules. For instance, a given expected workload at microservice 140 may result in an increase in allocated memory, while the same expected workload at microservice 150 may result in no change to allocated resources, or in a different change to a different resource allocation.

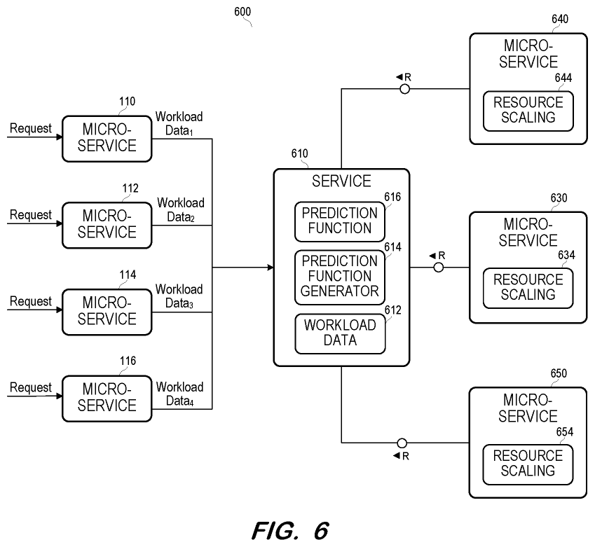

FIG. 6 illustrates resource scaling within multiple microservices in microservice-based system 600 according to some embodiments. System 600 includes service 610 to collect workload data 612 from entry microservices 110-116 as described above. Service 610 also includes prediction function generator 614 to generate workload prediction function 616 as described above.

According to the illustrated embodiment, interior microservices 630, 640 and 650 may selectively request their respective expected workloads from service 610. For example, microservice 630 transmits a request for an expected workload from service 610. In response, service 610 uses prediction function 616 and current workload data 612 to determine an expected workload for microservice 630, and returns the expected workload to microservice 630. Resource scaling component 634 may then determine whether to allocate resources to or de-allocate resources from microservice 630 based on the expected workload.

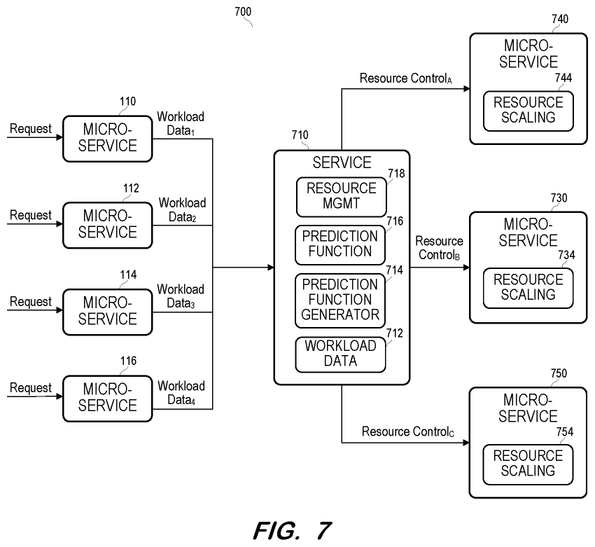

FIG. 7 illustrates resource scaling within multiple microservices in microservice-based system 700 according to some embodiments. Service 710 of system 700 collects workload data 712 from entry microservices 110-116 and includes prediction function generator 714 and prediction function 716 as described above. Service 710 also includes resource management component 718 to manage computing resources allocated to interior microservices 730, 740 and 750.

For example, resource management component 718 may periodically determine an expected workload for each of interior microservices 730, 740 and 750 based on prediction function 716 and current workload data 712. Based on the expected workloads, resource management component 718 may determine that computing resources should be allocated to or de-allocated from one or more of interior microservices 730, 740 and 750. Alternatively, resource management component 718 may determine, based on the expected workloads, a desired allocation of computing resources for each of interior microservices 730, 740 and 750. In either case, the determination may be based on microservice-specific rules or guidelines (not shown) which are known to resource management component 718.

Resource management component 718 provides a resource control instruction to each of interior microservices 730, 740 and 750 to control the resource allocation thereof. The resource control instruction may, for example, instruct each respective resource scaling component to perform microservice-specific resource allocations and/or de-allocations. In another example, a resource control instruction indicates a desired allocation of computing resources and each respective resource scaling component determines whether to allocate and/or de-allocate resources based on the desired resource allocation.

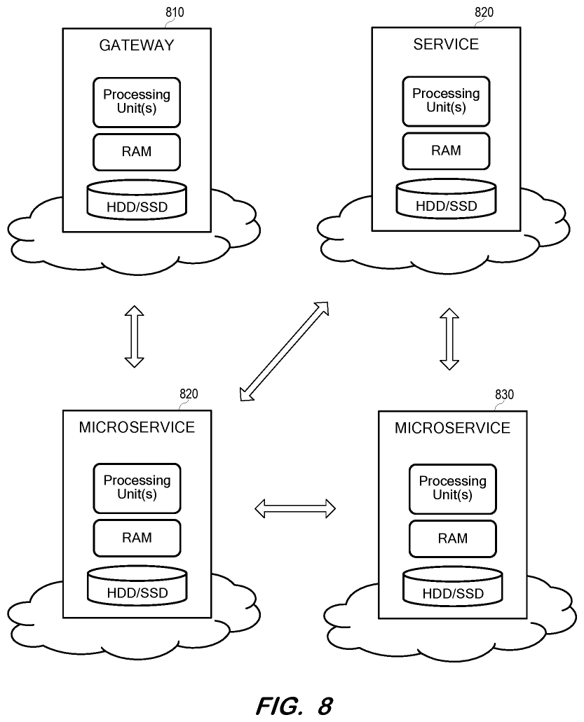

FIG. 8 illustrates a cloud-based deployment according to some embodiments. The illustrated components may comprise cloud-based compute resources residing in one or more public clouds providing self-service and immediate provisioning, autoscaling, security, compliance and identity management features.

Execution environments 810-840 may comprise servers or virtual machines of a Kubernetes cluster. Execution environments 810-840 may support containerized applications which provide one or more services to users. Execution environments 810 and 820 may execute a gateway and a central service such as cache 120, service 610 or service 710, and execution environments 830 and 840 may execute microservices of a microservice-based application as described herein.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of networks and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a first execution environment of a first microservice of a microservice-based application, the first execution environment comprising:
a first memory storing executable program code; and
a first one or more processing units to execute the executable program code to cause the first execution environment to:
receive an indicator of a workload of a second microservice of the microservice-based application;
determine, based on the indicator of the workload, an estimated future workload of the first microservice; and
re-allocate computing resources to the first microservice based on the estimated future workload.

2. A system according to claim 1,
a third execution environment of a third microservice of the microservice-based application, the third execution environment comprising:
a third memory storing third executable program code; and
a third one or more processing units to execute the third executable program code to cause the third execution environment to:
receive the indicator of the workload;
determine, based on the indicator of the workload, an estimated future workload of the third microservice, where the estimated future workload of the first microservice is not equal to the estimated future workload of the third microservice; and
re-allocate computing resources to the third microservice based on the estimated future workload of the third microservice.

3. A system according to claim 1,
the first one or more processing units to execute the executable program code to cause the system to:
receive a second indicator of a second workload of a third microservice of the first microservice-based application,
wherein the determination of the estimated future workload of the first microservice is based on the indicator of the workload and the second indicator of the second workload.

4. A system according to claim 3,
a third execution environment of a third microservice of the microservice-based application, the third execution environment comprising:
a third memory storing third executable program code; and
a third one or more processing units to execute the third executable program code to cause the third execution environment to:
receive the indicator of the workload and the second indicator of the second workload;
determine, based on the indicator of the workload and the second indicator of the second workload, an estimated future workload of the third microservice, where the estimated future workload of the first microservice is not equal to the estimated future workload of the third microservice; and
re-allocate computing resources to the third microservice based on the estimated future workload of the third microservice.

5. A system according to claim 1, wherein determination of the workload is based on a mapping of workloads of a plurality of entry microservices to a workload of the first microservice.

6. A system according to claim 5, the first one or more processing units to execute the executable program code to cause the first execution environment to:
receive a second indicator of a second workload of the second microservice of the microservice-based application;
determine, based on the second indicator of the second workload and a second mapping of workloads of the plurality of entry microservices to workloads of the plurality of interior microservices, a second estimated future workload of the first microservice; and
re-allocate computing resources to the first microservice based on the second estimated future workload.

7. A system according to claim 6, wherein re-allocation of computing resources to the first microservice based on the estimated future workload comprises increasing of the computing resources, and
wherein re-allocation of computing resources to the first microservice based on the second estimated future workload comprises decreasing of the computing resources.

8. A method comprising:
receiving, at a first microservice of a microservice-based application, an indicator of a workload of an entry microservice of the microservice-based application;
determining, based on the indicator of the workload, an estimated future workload of the first microservice; and
re-allocating computing resources to the first microservice based on the estimated future workload.

9. A method according to claim 8, further comprising:
receiving the indicator of the workload at a second microservice of the microservice-based application;
determining, based on the indicator of the workload, an estimated future workload of the second microservice, where the estimated future workload of the first microservice is not equal to the estimated future workload of the second microservice; and
re-allocate computing resources to the second microservice based on the estimated future workload of the second microservice.

10. A method according to claim 8, further comprising:
receiving a second indicator of a second workload of a second entry microservice of the first microservice-based application,
wherein the determination of the estimated future workload of the first microservice is based on the indicator of the workload and the second indicator of the second workload.

11. A method according to claim 10, further comprising:
receiving the indicator of the workload and the second indicator of the second workload at a second microservice of the microservice-based application;
determining, based on the indicator of the workload and the second indicator of the second workload, an estimated future workload of the second microservice, where the estimated future workload of the first microservice is not equal to the estimated future workload of the second microservice; and
re-allocating computing resources to the second microservice based on the estimated future workload of the second microservice.

12. A method according to claim 8, wherein determining the workload is based on a mapping of workloads of a plurality of entry microservices to a workload of the first microservice.

13. A method according to claim 12, further comprising:
receiving a second indicator of a second workload of the entry microservice of the microservice-based application;
determining, based on the second indicator of the second workload and a second mapping of workloads of the plurality of entry microservices to workloads of the plurality of interior microservices, a second estimated future workload of the first microservice; and
re-allocating computing resources to the first microservice based on the second estimated future workload.

14. A method according to claim 13, wherein re-allocating computing resources to the first microservice based on the estimated future workload comprises increasing the computing resources, and
wherein re-allocation of computing resources to the first microservice based on the second estimated future workload comprises decreasing the computing resources.

15. A method comprising:
receiving an indicator of a workload of an entry microservice of the microservice-based application;
determining, based on the indicator of the workload, an estimated future workload of a first microservice of the microservice-based application; and
transmitting the estimated future workload to a first execution environment of the first microservice.

16. A method according to claim 15, further comprising:
determining, based on the indicator of the workload, an estimated future workload of a second microservice of the microservice-based application, where the estimated future workload of the first microservice is not equal to the estimated future workload of the second microservice; and
transmitting the estimated future workload of the second microservice to a second execution environment of the second microservice.

17. A method according to claim 15, further comprising:
receiving a second indicator of a second workload of a second entry microservice of the first microservice-based application,
wherein the determination of the estimated future workload of the first microservice is based on the indicator of the workload and the second indicator of the second workload.

18. A method according to claim 17, further comprising:
determining, based on the indicator of the workload and the second indicator of the second workload, an estimated future workload of a second microservice of the microservice-based application, where the estimated future workload of the first microservice is not equal to the estimated future workload of the second microservice; and
transmitting the estimated future workload of the second microservice to a second execution environment of the second microservice.

19. A method according to claim 15, wherein determining the workload is based on a mapping of workloads of a plurality of entry microservices to a workload of the first microservice.

20. A method according to claim 19, further comprising:
receiving a second indicator of a second workload of the entry microservice of the microservice-based application;
determining, based on the second indicator of the second workload and a second mapping of workloads of the plurality of entry microservices to workloads of the plurality of interior microservices, a second estimated future workload of the first microservice; and
transmitting the second estimated future workload to the first execution environment of the first microservice.
